(19) United States
(12) Patent Application Publication
(10) Pub. No.: US 2018/0009191 A1
(43) Pub. Date: Jan. 11, 2018

(54) FORM-STABLE COMPOSITE MATERIAL WITH A LAYER OF FIBER-REINFORCED RECYCLED MATERIAL

(71) Applicant: Röchling Automotive SE & Co. KG, Mannheim (DE)

(72) Inventors: Klaus Pfaffelhuber, Augsburg (DE); Dennis Schroth, Worms (DE); Christian Arlt, Altrip (DE); Reinhard Wirth, Gaggenau (DE); Erhard Lehmbruck, Westhofen (DE)

(73) Assignee: Röchling Automotive SE & Co. KG

(21) Appl. No.: 15/623,760

(22) Filed: Jun. 15, 2017

(30) Foreign Application Priority Data
Jul. 11, 2016 (DE) 10 2016 212 589.3

(51) Int. Cl. B32B 5/18; B32B 5/02; B32B 15/04

(52) U.S. Cl. CPC B32B 5/18; B32B 15/04; B32B 5/022; B32B 2305/70

(57) ABSTRACT

A form-stable composite material with two flexible layers, between which is accommodated a layer with fiber-reinforced recycled ground material, comprising thermoplastically bound fibers, wherein grains of the ground material are firmly bonded to one another and to the flexible layers, the layer of ground material being porous.

The present invention relates to a form-stable composite material with two flexible layers, between which is accommodated a layer with fiber-reinforced recycled ground material, comprising thermoplastically bound fibers, wherein grains of the ground material are firmly bonded to one another and to the flexible layers.

### BACKGROUND OF THE INVENTION

Such a composite material is known, for example, from DE 10 2005 029 229 A1. This publication discloses plates made of ground material of long glass fiber-reinforced polypropylene, wherein the ground material of long glass fiber-reinforced polypropylene is located between two nonwoven mats. The layering of nonwoven mats and ground material arranged between them is fed to a heating press, where all the melting parts of the material are melted, pressed and compacted. Thus, the result is a solid plate free of entrained gases, in which the originally outer nonwoven mats are enclosed by the melted material of the ground material and/or the nonwoven mats themselves. The known plates which have been formed using the ground material of long glass fiber-reinforced polypropylene therefore comprise a solid polypropylene matrix in the outermost zones of which non-melting fiber parts of the nonwoven mats and glass fibers of the ground material between them are incorporated.

From DE 101 47 527 A1 it is known to produce interior parts of a motor vehicle using a mat-like composite of two flexible outer layers and an intermediate core layer of comminuted industrial waste. The industrial waste originates from comminuted cuttings which are obtained during the primary production of other interior parts of a motor vehicle.

The cuttings are mixed with other components. For example, comminuted waste from interior parts of a motor vehicle, fibers or particles, such as glass fibers, mineral wool, carbon fibers, polypropylene-, polyamide-PES fibers, etc., may be added to the cuttings. Foam flakes may also be added to the cuttings. According to DE 101 47 527 A1 the mat-like composite made of flexible outer layers and the intermediate core layer with comminuted industrial waste is preferably formed by a thread system, that is, for example, by sewing together the outer layers. In addition, granular binder can be added to the comminuted industrial waste which, during the subsequent processing of the mat-like composite, melts under the influence of pressure and heat and re-solidifies upon cooling.

DE 10 2005 027 257 A1 discloses pressed plates with a core made of ground material of long glass fiber-reinforced polypropylene and top layers of three-layer composite foil. The composite foils of the outer layers have a polypropylene layer on the side facing the ground material which can form a firmly bonded weld with the ground material of the long glass fiber-reinforced polypropylene of the core layer.

A disadvantage of the known composite materials with at least one layer of fiber-reinforced recycled ground material is their poor sound absorption capacity. This makes them unsuitable for use in noise-reducing applications in which a reduction in sound emission is desired, so that in this case expensive composite materials from primary production have to be used.

### SUMMARY OF THE INVENTION

It is an object of the present invention to further develop a form-stable composite material of the type mentioned above in such a way that it exhibits an increased sound-absorbing effect compared with the composite materials known from the prior art, wherein, in order to keep the production costs of the composite material low and to keep the disposal costs low in other production areas by recycling arising production waste, it is still relied on recycled ground material for the formation of the composite material.

According to the invention this object and others are achieved by a generic form-stable composite material, wherein the layer of ground material is porous.

Due to the porosity of the layer of ground material the layer of ground material and thus the form-stable composite material overall are sound-absorbing. The degree of sound absorption as well as the absorption frequency ranges can be varied or adjusted by selecting or adjusting the porosity of the layer of ground material.

Preferably, the flexible layers or cover layers are also porous in order to further enhance the sound-absorbing effect of the composite material.

The porosity of the layer of ground material—as well as preferably that of the flexible layers—is an open porosity so that the layer of ground material, taken alone, but preferably the overall composite material, permits a flow of gas in the thickness direction, wherein the layer of ground material or preferably the entire composite material provides flow resistance of this gas flow.

The composite material can have a weight per unit area of, for example, 1000 or 1500 g/m² to 5000 g/m², the flow resistance of the composite material progressively increasing with the weight per unit area, from an area-specific flow resistance of, for example, 200 to 250 Pas/m at a weight per unit area of about 1500 g/m² to a specific flow resistance of about 1800 to 1900 Pas/m at a weight per unit area of about 5000 g/m². The progressive increase of the specific flow resistance can be seen in the fact that the flow resistance can be between 350 and 450 Pas/m at a weight per unit area of about 2500 g/m², but between 950 and 1050 Pas/m at a weight per unit area of about 4000 g/m².

By varying the structure of the flexible layers between which the recycled material is accommodated, the flow resistance can be varied independently of the recycled ground material.

Preferably, for any subsequent recycling, the recycled material is single-origin, i.e. the grains of the ground material of the layer of recycled ground material have substantially, such as at least 90% by weight, preferably at least 94% by weight the same content and structure, for example because they are all derived from the same starting product.

Preferably, the grains of grains of ground material are LWRT material, that is to say a ground material of a fiber-reinforced low-weight thermoplast (LWRT=“Low Weight Reinforced Thermoplast”), so that the grains of ground material already have a first grain intrinsic porosity. This first porosity, which is based on the nature of the grains of ground material as LWRT ground material, can be maintained during the processing of the composite material into a plate-shaped semi-finished product, since it is sufficient to transfer just as much heat into a crude layer structure made of two layers and recycled ground material disposed between them, so that the grains of ground material melt at their grain boundaries—and preferably only at their grain boundaries—so that the grains of ground material can be fused under pressure at their melted grain boundaries, without changing the porosity inside the grains by doing so.

In the same manner, the grains of ground material, which contact a flexible layer with a grain boundary or can be brought into contact with a flexible layer by pressure in a mold, can be melt-bonded to the flexible layer which contacts them, so that not only there is a firm bond between the grains of ground material, but also between the flexible layers and the grains of ground material. Preferably, this firm bond is realized by the compatible thermoplastic materials present in the flexible layers on the one hand and in the grains of ground material on the other hand, so that the form-stable composite material according to the invention is preferably free of additional binders.

Thus, the production process of the form-stable composite material, as described above, is a type of sintering process in which the grains of ground material are melted only at their outer surface (grain boundary), so that by applying pressure on the layering to be processed, said fusion bond can be formed between the grains and between the grains and the flexible layers.

However, it is also contemplated to completely melt the grains of ground material, for example if a composite material is to be formed which is more strongly compacted than the starting ground material or/and if the form-stable composite material is to have a higher mechanical strength. If—as is generally preferred—LWRT recyclate is used as ground material, the first porosity in the grains can be maintained in the grains of ground material even when the thermoplastic binder plastic is completely melted. However, since more thermoplastic plastic mass can flow when completely melted than when only the grain boundaries are melted, a stronger bond between the grains is possible, as well as between the grains and the flexible layers.

In addition to the first porosity present within the grains, the layer of ground material can have a second porosity between the grains, for example because gaps form between the grains, which are filled only by gas. Depending on the degree of densification of the crude layer structure during the production of the composite, these gaps can be retained. This second porosity between the grains also contributes to sound absorption. The second porosity can therefore be sound-absorbing in a different frequency range than the first porosity.

Typically, the mean pore size of the second porosity is greater than the mean pore size of the first porosity. This also depends on the mean grain size of the grains of ground material used in the recycled material. Typically, the mean pore size of the second porosity is greater than the mean pore size of the first porosity by more than the factor of 5, preferably by more than the factor of 10.

The weight proportion of fibers of the layer of ground material is preferably between 18 and 32% by weight, particularly preferably between 20 and 29% by weight. The porosity is between 50 and 90% by volume, preferably between 70 and 90% by volume. This means, the gas fraction of the volume taken up by a grain of ground material is preferably greater than the solids fraction.

Since the grains of ground material are preferably produced from an LWRT material, it is preferred that the grains of ground material comprise fibers that are bound by a thermoplastic binder plastic, in particular by a polyolefin, and that are made of a material which is form-stable at the melting temperature of the binder plastic, in particular glass fibers, mineral fibers, natural fibers, fibers made of a thermoset or a thermoplastic material with a higher melting point than the binder plastic, in particular consist of thermoplastically bonded fibers. Preferably, the thermoplastic binder plastic is polypropylene and the reinforcing fibers are glass fibers, although this is not the only preferred solution. For example, fibers made of polyester, for example PET, can also be used.

When producing the composite material, the grains of ground material can be readily poured or sprinkled on one of the flexible layers, which then forms the lower layer, and are covered by the second flexible layer, so that this crude layer arrangement can then be subjected to a pressure and heat treatment. The grains of ground material which are still recognizable as such in the finished composite material, may have a most comment grain size in the range from 1 to 4 mm, depending on the functional orientation of the composite material, with the preferred most frequent grain size being then in the range between 2 and 4 mm. Another composite material according to the invention is conceivable, which utilizes larger grains of ground material. In this case, the most frequent grain size is in the range from 2 to 8 mm, with the most frequent grain size preferably being in a range of 4 to 8 mm. Preferably, more than 90%, even more than 95%, of the grains of ground material are in the wider ranges mentioned above, i.e. from 1 to 4 mm or from 2 to 8 mm. Likewise, preferably more than 50%, in the case of the range of 2 to 4 mm even more than 70% of the grains of ground material are in the preferred narrower grain size ranges mentioned above.

The most comment fiber length which can be found in the grains of ground material is preferably in the range from 1 to 4 mm, preferably from 1.5 to 3 mm.

In addition to the thermoplastic binder plastic and the reinforcing fibers bound thereby, the layer of ground material can also have traces of polyester and other materials, which can be found, for example, by cover layers, such as nonwovens or foils, on the LWRT starting products also in the ground material produced therefrom.

For the improvement of sound absorption or, in principle, for the improvement of the noise-reducing effect of the composite material discussed herein with recycled material, it has been found to be advantageous if the layer of ground material comprises metal foil pieces. These metal foil pieces can form sound reflection surfaces which extend the path of sound in the thickness direction through the composite so that the effective thickness of the composite material can be increased compared with its actual physical thickness for the sound passage. Thereby, the sound absorption caused by the porous material can be enhanced.

Preferably, the metal foil pieces are randomly distributed and non-oriented in the layer of ground material. The preferred mean diameter of a metal foil piece corresponds approximately to the abovementioned preferred dimensions for the most frequent grain size.

The metal foil pieces are preferably located at the grain boundaries of grains of ground material, so that they are bound to the location of the grain carrying them during pouring or spreading of the ground material on a flexible layer. As a result, a separation of grains of ground material and metal foil pieces can be prevented, which would give rise to concern in the case where grains on the one hand and metal foil pieces on the other are poured separately in bulk, for example on account of vibrations when conveying the flexible layer in the direction of production progress.

The bonding of the metal foil pieces to the grains of ground material can be achieved in a simple manner by processing an LWRT starting material with a metal foil provided flat thereon into ground material. The metal foil can be provided on one or both sides on the LWRT starting material. The metal foils and thus the resultant metal foil pieces can be microperforated, so that they have not only a reflective effect, but are also sound-permeable in places.

The use of grains of ground material from a grinding process of an LWRT material covered on one or both sides with metal foil, in particular aluminum foil, furthermore ensures that the grains of ground material are not completely surrounded by metal foil, so that they have sufficient grain boundary surface areas which can lead to a firm bond with other grains of ground material by melting. Thus, even if metal foil pieces are present at their grain boundaries, the grains of ground material can also be melt-bonded to one another at their grain boundaries.

One of the or both flexible layers may have a nonwoven and/or a metal foil, in particular a microperforated metal foil, and/or a plastic foil. The nonwoven can have fibers of different materials, wherein preferably binder fibers made of the thermoplastic binder plastic of the grains of ground material or of at least one plastic in the nonwoven that is compatible with this plastic may be present. For example, a nonwoven can have polyolefin and polyester fibers, in particular polypropylene and PET fibers, in equal weight proportions. The weight per unit area of one or both flexible layers can preferably be between 200 and 400 g/m², particularly preferably between 250 and 350 g/m². A solid plastic foil may be provided to prevent the fibers from being discharged from the recycled material to the outside or, more importantly, to prevent an ingress of moisture into the porous layer of recycled ground material. The metal foil can be provided as a flame barrier in order to prevent or at least delay flames from spreading to a component made of the composite material according to the invention. The metal foil may be provided with an adhesive layer on its side facing the layer of recycled ground material in order to bind it to a layer of the flexible layers or the layer of ground material.

The flexible layers which accommodate the layer of recycled ground material between them can in turn themselves be multi-layered and, for example, comprise both a nonwoven and a microperforated metal foil or a nonwoven and a plastic foil or all three components.

The form-stable composite material can have more than one layer of recycled ground material, wherein preferably a flexible layer is provided between two layers of recycled ground material, for example again a nonwoven, a metal foil or/and a plastic foil.

As a semi-finished product the composite material preferably has a thickness in the range from 5 to 12, particularly preferably from 7 to 9 mm. When the sound absorption of the composite material and of a component formed therefrom is more important than the required component strength and stiffness, the composite material can be made even thicker, for example with a thickness of 10 to 25 mm, preferably 12 to 20 mm.

In further processing to a component the composite material proposed herein can be compacted locally to a varying degree, so that the form-stable composite material has different thicknesses and densities at different points. This applies in particular to a flat composite component produced therefrom, which is likewise encompassed by the present invention.

The above metal foils, which may be comprised by the flexible layers, have a preferred thickness of 45 to 150 μm. The metal foil can be nubby or studded or, as already indicated above, perforated, in particular microperforated.

A plastic foil, which is preferably a polypropylene film, as a flexible layer or part of a flexible layer has a thickness in the range from 100 to 300 μm.

The present invention also relates to a flat composite component produced from a form-stable composite material as described above or by means of its participation, wherein “flat” is to be understood to mean that the composite component has a substantially smaller dimension in its thickness direction than in its two surface directions of extension which are both orthogonal to the thickness direction (D) and mutually orthogonal. The thickness direction can be locally differently oriented since the flat composite component can be locally curved for its application, in particular in a motor vehicle, about at least one axis of curvature which is orthogonal to the local axis of extension of the thickness direction. In fact, the flat composite component, which is formed at least with the participation of the form-stable composite material configured as described above, will be curved about several differently oriented axes of curvature.

These and other objects, aspects, features and advantages of the invention will become apparent to those skilled in the art upon a reading of the Detailed Description of the invention set forth below taken together with the drawing which will be described in the next section.

### BRIEF DESCRIPTION OF THE DRAWING

The invention may take physical form in certain parts and arrangement of parts, a preferred embodiment of which will be described in detail and illustrated in the accompanying drawing which forms a part hereof and wherein:

FIG. 1 shows a rough schematic cross-sectional view through a form-stable composite material according to the present invention.

### DESCRIPTION OF PREFERRED EMBODIMENTS

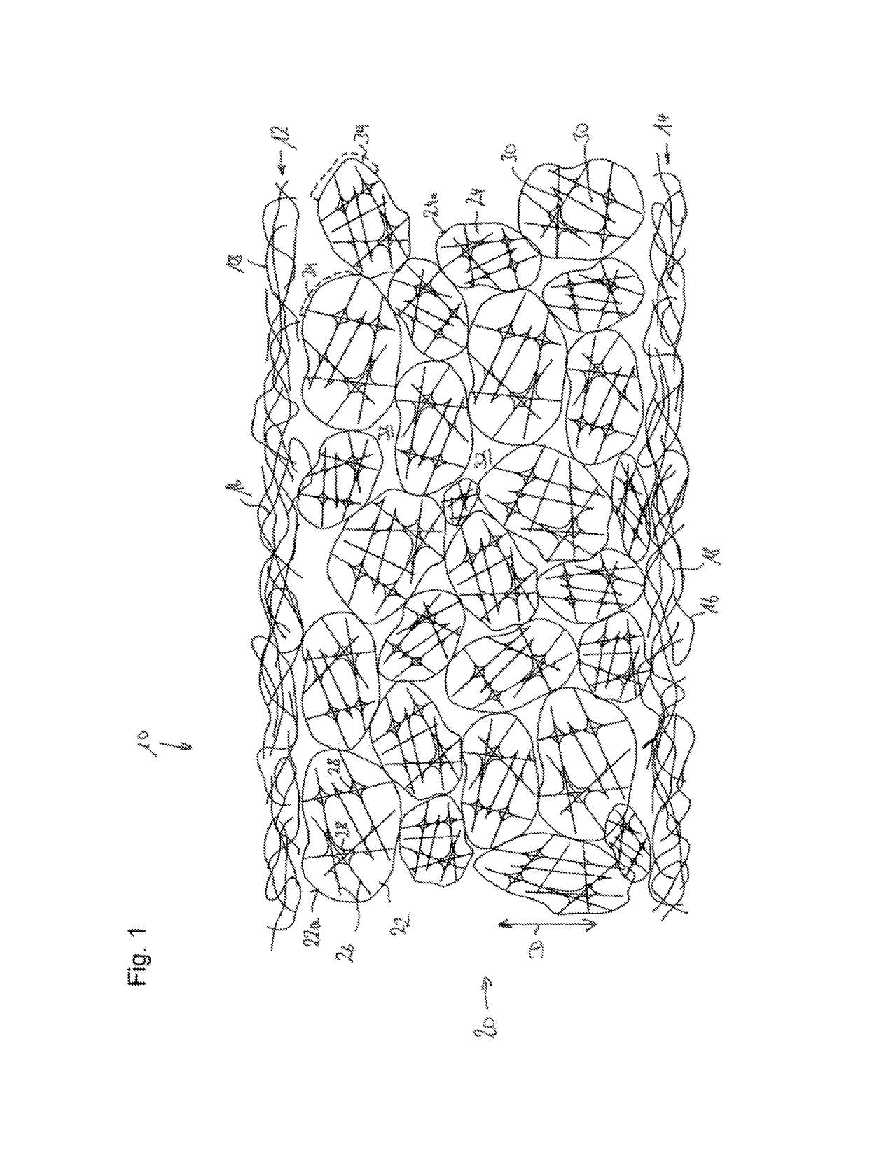

Referring now to the drawing wherein the showings are for the purpose of illustrating preferred and alternative embodiments of the invention only and not for the purpose of limiting the same, FIG. 1 shows a cross-sectional view through an exemplary embodiment of a form-stable composite material according to the invention that is indicated generally by reference numeral 10. The composite material 10 comprises a first and a second flexible layer 12 and 14, respectively, which are shown as layers of nonwovens in the illustrated example. The layers of nonwoven 12 and 14 can each have different fibers, for example thermoplastic binder fibers 16 made of a polyolefin, in particular polypropylene, and reinforcing fibers 18 made of a material which is form-stable at the melting temperature of the thermoplastic binder plastic of the thermoplastic binder fibers 16. For example, the reinforcing fibers 18 may be formed from polyethylene terephthalate.

In addition or alternatively to the layers of nonwoven 12 and 14, the flexible layers 12 and 14 can have other or additional layers, for example a solid plastic foil or/and a metal foil, in particular a microperforated aluminum foil.

Between the flexible layers 12 and 14 there is a layer of ground material 20 made of LWRT recyclate. The layer of ground material 20 comprises a plurality of grains of ground material 22, 24, etc., which are present in a size distribution depending on the selected grinding method. For example, the grains of ground material 22, 24, etc. of the layer of ground material 20 have a mean grain diameter of 0.5 to 8 mm, 90% of the grains 22, 24 having a mean diameter of 2 to 8 mm.

In the illustrated example, the grains of ground material 22, 24, etc. comprise thermally stable fibers, for example glass fibers 26, which are shown as straight fibers in comparison to the tangled fibers of the layers of nonwoven 12 and 14. These glass fibers 26 are bonded to one another by a thermoplastic binder plastic 28. The thermoplastic binder plastic 28 was originally present as fibers, similar to the thermoplastic binder fibers 16 in the layers of nonwoven 12 and 14, that is, in the primary production of the LWRT that is now present as LWRT recyclate. As is known for LWRTs, the binder fibers were melted and have wetted the thermally stable glass fibers 26 so that cooling of the LWRT resulted in thermoplastic bonding of the glass fibers 26. This structure is still present in grains 22, 24.

Pores 30 of a first porosity which is found exclusively in the grain interior are formed between the thermoplastically bonded glass fibers 26 in grains 22 and 24.

In addition, there is a second porosity with pores 32 which can be properly referred to as interbody pores 32, in the areas between the grains of ground material 22, 24, etc. The pore size of the pores 32 of the second porosity is significantly greater than the mean pore size of the pores 30 of the first porosity in the grains of ground material 22, 24, etc.

Pores 22, 24, etc., are firmly bonded to one another at their grain boundaries 22a, 24a. Likewise, grains 22, 24, etc. are firmly bonded with their grain boundaries 22a to the layers of nonwoven 12 and 14, in particular with the aid of binder fibers 16 in the two layers 12 and 14.

In the production of composite material 10, ground material was loosely spread or poured onto the lower layer of nonwoven 14, and this spread or poured material was covered with the upper layer of nonwoven 12. This crude layer arrangement was fed to a heatable mold in which grain boundaries 22a, 24a of grains 22, 24, etc., were melted by heat input while regions lying more in the grain interior were not heated until the binder plastic 28 melted. The grain boundaries 22a, 24a of adjacent grains 22, 24, etc., which are in contact with one another, have thus bonded firmly via the common binder plastic 28, which is melted in the grain boundary region. At the same time, pressure was exerted on the crude layer arrangement so that the composite material or the layer of ground material 20 accommodated therein has a sinter-like structure with a visible granularity whose grains are firmly bonded together by fusion in their surface regions—and preferably only in these regions.

The binder fibers 16 also were partially melted upon heat input into the crude layer arrangement, resulting in firmly bonding of the layers of nonwoven 12 and 14 to grains 22, 24 at their grain boundaries 22a, 24a.

By using LWRT recyclate, the composite material 10 can be produced cost-effectively with sufficiently high mechanical strength, having very good sound-absorbing properties due to both the porosity described within grains 22, 24, etc., and between the grains.

Grains 22, 24, etc. can be partly covered by metal foil 34 at their grain boundaries 22a, 24a, as is roughly indicated schematically in FIG. 1.

Preferably, metal foil pieces 34 originate from the grinding of an LWRT component covered at least on one side with a metal foil. The metal foil pieces 34 form sound reflectors which are randomly arranged and oriented in the layer of ground material 20, which effectively extend the path of sound in the thickness direction D through the composite material 10 and thereby enhance its absorption.

The form-stable composite material 10 of FIG. 1 can be brought into a three-dimensional shape by pressing with the action of heat. Preferably, shell components which are well suited as sound-absorbing cladding of functional areas in vehicles are produced from the flat composite material 10.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-12. (canceled)

13. A form-stable composite material with two flexible layers, between which is accommodated a layer with fiber-reinforced recycled ground material, comprising thermoplastically bound fibers, wherein grains of the ground material are firmly bonded to one another and to the flexible layers, the layer of ground material being porous.

14. The form-stable composite material according to claim 13, wherein the layer of ground material has grains of ground material which are melt-bonded to one another at their grain boundaries, wherein the grains of ground material have a first porosity within their grain boundaries.

15. The shape-stable composite material according to claim 14, wherein the layer of ground material between the grains of the ground material has a second porosity.

16. The shape-stable composite material according to claim 15, wherein the mean pore size of the second porosity is greater than the mean pore size of the first porosity by more than a factor of 5.

17. The shape-stable composite material according to claim 15, wherein the mean pore size of the second porosity is greater than the mean pore size of the first porosity by more than a factor of 10.

18. The form-stable composite material according to claim 13, wherein the grains of ground material comprise fibers that are bound by a thermoplastic binder plastic and are made of at least one of a material which is form-stable at the melting temperature of the binder plastic and made of a thermoplastic material with a higher melting point than the binder plastic.

19. The form-stable composite material according to claim 18, wherein at least one of the thermoplastic binder includes a polyolefin, the grains of ground material comprise fibers made of at least one of glass fibers, mineral fibers, natural fibers, fibers made of a thermoset and the thermoplastic material with a higher melting point than the binder plastic includes thermoplastically bonded fibers.

20. The form-stable composite material according to claim 18, wherein the grains of ground material are firmly bonded to one another by the thermoplastic binder plastic.

21. The form-stable composite material according to claim 13, wherein the grains of ground material have a most frequent grain size in the range from 1 to 4 mm.

22. The form-stable composite material according to claim 21, wherein the grains of ground material have a most frequent grain size in the range from 2 to 4 mm.

23. The form-stable composite material according to claim 13, wherein the grains of ground material have a most frequent grain size in the range from 2 to 8 mm.

24. The form-stable composite material according to claim 23, wherein the grains of ground material have a most frequent grain size in the range from 4 to 8 mm.

25. The form-stable composite material according to claim 13, wherein the grains of ground material have a most frequent fiber length in the range from 1 to 4 mm.

26. The form-stable composite material according to claim 25, wherein the grains of ground material have a most frequent fiber length in the range from 1.5 to 3 mm.

27. The form-stable composite material according to claim 13, wherein the layer of ground material layer comprises metal foil pieces.

28. The form-stable composite material according to claim 27, wherein the layer of ground material has grains of ground material which are fused to one another at their grain boundaries, wherein metal foil pieces are located at the grain boundaries of grains of ground material.

29. The mold-stable composite material according to claim 13, wherein one or both flexible layers have at least one of a nonwoven, a metal foil and a plastic foil.

30. The mold-stable composite material according to claim 29, wherein the one or both flexible layers includes a microperforated metal foil.

31. A flat composite component which has a substantially smaller dimension in its thickness direction than in its two surface directions of extension which are both orthogonal to the thickness direction and mutually orthogonal, comprising a composite material according to claim 13, wherein the composite component is curved locally around at least one curvature axis orthogonal to the local extension axis of the thickness direction.
